(19) United States
(12) Patent Application Publication
(10) Pub. No.: US 2018/0141242 A1
(43) Pub. Date: May 24, 2018

(54) APPARATUS FOR CARRYING A FIBER COMPOSITE RESIN SYSTEM IN A HEAT TRANSFER DEVICE

(71) Applicant: Airbus Operations GmbH, Hamburg (DE)

(72) Inventors: Heike Lindhorst, Hamburg (DE); Alexander Gillessen, Hamburg (DE); Paulin Fideu Siagam, Hamburg (DE); Konstantin Schubert, Hamburg (DE)

(21) Appl. No.: 15/816,081

(22) Filed: Nov. 17, 2017

(30) Foreign Application Priority Data
Nov. 22, 2016 (DE) 102016122536.3

(51) Int. Cl. B29C 35/02

(52) U.S. Cl. CPC B29C 35/0227; B29K 2307/04

(57) ABSTRACT

An apparatus for carrying a fiber composite resin system in a heat transfer device, in particular an autoclave, for transferring heat between the fiber composite resin system and a directed gas flow, to produce a fiber composite aircraft component. The apparatus comprises a carrier structure for carrying the fiber composite resin system, the carrier structure having at least one flow path which, when the apparatus is accommodated in the heat transfer device, extends from an inlet on a side facing the directed gas flow along the fiber composite resin system accommodated by the carrier structure, to allow heat exchange between the gas flow in the flow path and the fiber composite resin system, and a diverting device for diverting at least a part of the directed gas flow when the apparatus is accommodated in the heat transfer device, to feed this part to the carrier structure flow path.

### CROSS-REFERENCES TO RELATED APPLICATIONS

This application claims the benefit of the German patent application No. 10 2016 122 536.3 filed on Nov. 22, 2016, the entire disclosures of which are incorporated herein by way of reference.

### TECHNICAL FIELD

The present invention relates to an apparatus for carrying a fiber composite resin system in a heat transfer device, for example an autoclave. The fiber composite resin system may be an uncured prepreg. The heat transfer device is suitable for transferring heat between the fiber composite resin system and a gas flow. The apparatus comprises a carrier system for carrying the fiber composite resin system, having a flow path which, when the apparatus is accommodated in the heat transfer device, extends from a side facing the gas flow along the workpiece accommodated by the carrier structure, in order, in this way, to allow heat exchange between the gas flow in the flow path and the fiber composite resin system.

### BACKGROUND OF THE INVENTION

The modern manufacture of fiber composite components for the aviation industry usually takes place in autoclaves in that an uncured prepreg is placed on a surface adapted to the contour of the finished product. In order to allow the transport of the component, a reinforcing substructure, frequently in the form of a beam structure or a cross structure welded from cut panels, is provided under this surface.

FIG. 1 shows such a substructure 50 known from the prior art. The substructure 50 is formed in a rectangular manner and comprises a top side 51 on which an uncured prepreg, as an example of a fiber composite resin system, is able to be placed. Provided beneath the top side 51 is a honeycomb-like structure 52 which is connected to the top side 51 and supported on a plurality of feet 53. The substructure 50 represents a carrier structure for carrying the fiber composite resin system.

The honeycomb-like structure 52 is constructed from individual chambers 54 which each have an opening 55 in every side face, i.e., in every face with an extent component perpendicular to the surface 51. Thus, the honeycomb-like structure 52 as a whole also has openings 55 in every side face. To be more precise, the honeycomb-like structure 52 comprises openings 55 in the front face 56, in the rear face 61, shown in FIG. 2, on the opposite side from the front face, and in the two-opposite side faces 57 of the honeycomb-like structure, which are arranged between the front face 56 and rear face 61.

Each of the chambers 54 of the honeycomb-like structure 52 is thus connected to every other chamber 54 via a flow path. In particular, the honeycomb-like structure 52 has a flow path between the openings 55 of the chambers 54 in the front face 56 and the openings 55 of the chambers 54 in the side faces 57 of the honeycomb-like structure 52. Likewise, the honeycomb-like structure 52 comprises a flow path between the openings 55 of the chambers 54 in the front face 56 and the openings of the chambers in the rear face 61 on the opposite side from the front face.

In order to cure the fiber composite resin system, which is provided on the top side 51 of the carrier structure 50, the entire carrier structure 50 together with the workpiece W is pushed into an autoclave 60, as can be seen in FIGS. 2 and 3. Subsequently, the fiber composite resin system is subjected to a directed gas flow G in order to supply heat to or withdraw heat from the resin system via the gas. A part of the directed gas flow G in this case also passes into the chambers 54 of the honeycomb-like structure 52 through the openings 55 in the front face 56.

However, these apparatuses known from the prior art have the drawback of long process times and low energy efficiency.

### SUMMARY OF THE INVENTION

Accordingly, it is an object of the present invention to provide an apparatus for carrying a fiber composite resin system in a heat transfer device for transferring heat between the fiber composite resin system and a gas flow, which allows short process times and low energy consumption of the heat transfer device.

The invention is based on the concept that the long process times and the high energy consumption of the apparatuses in the prior art are due primarily to the fact that a large part of the gas flow in the autoclave moves away from the fiber composite resin system and, thus, is involved in the heat exchange to only a small extent. Furthermore, the honeycomb-like configuration of the carrier structure with lateral openings therein has the result that, in particular, in the rear region of the honeycomb-like structure, heat exchange no longer occurs between the gas flow and the structure. This can be substantially due to the fact that the gas flow seeks the path of least resistance and therefore passes out of the openings in the side face in the front region of the carrier structure. This results in uneven heating of the carrier structure and thus of the fiber composite resin system located thereon, in turn resulting in long process times and a high energy requirement.

The present invention makes use of this finding and provides an apparatus for carrying a fiber composite resin system, in particular an uncured prepreg, in a heat transfer device for transferring heat between the fiber composite resin system and a directed gas flow, which has a carrier structure for carrying the fiber composite resin system, wherein the carrier structure has at least one flow path which, when the apparatus is accommodated in the heat transfer device, extends from a side facing the directed gas flow along the fiber composite resin system accommodated by the carrier structure, in order, in this way, to allow heat exchange between the gas flow in the flow path and the fiber composite resin system, and a diverting device for diverting at least a part of the directed gas flow in order to feed this part additionally to the flow path of the carrier structure. In the context of the present invention, additional feeding is understood as meaning that the diverted part is fed in addition to the part already entering the honeycomb-like structure without being diverted. According to the invention, diverting of a flow is understood as being a macroscopic change in direction of the flow. In other words, the diverting device changes the direction of flow of the gas flow. The heat transfer device can be an autoclave and/or a furnace which preferably has a circular symmetrical cross section, particularly preferably a circular cross section. Other cross-sectional shapes, for example a rectangular or a square cross section, are also conceivable here. The fiber composite resin system can serve, in particular, for manufacturing an extensive fiber composite component for aviation, for example a fuselage shell or wing shell, a tail unit part or a relatively large rib. Other fiber composite parts are also conceivable in this connection.

The apparatus can preferably be used in an open-mold process, i.e., a process using vacuum films, in which heat is introduced into the process via the surrounding fluid and is dissipated thereby.

As a result of the provision of the diverting device, a greater proportion of the gas flow present in the heat transfer device is fed to the carrier structure. In other words, the directed gas flow is forced into the flow path of the carrier structure by the diverting device. As a result, a greater percentage of the gas flow is actively involved in the heat exchange with the fiber composite resin system. This reduces the process times and the energy requirement since the exchanged heat output between these components can be increased. Furthermore, the increase in the gas flow which flows through the carrier structure as a result of the provision of the diverting device, is considered to be advantageous in that heat transfer between the gas and the fiber composite resin system via the carrier structure located in between is particularly effective on account of relatively high heat transfer coefficients. This effect thus additionally contributes toward short process times and high energy efficiency. Ultimately, the increase in the gas flow through the carrier structure results in more uniform heating/cooling, this in turn resulting in smaller temperature gradients within the structure and thus making quicker temperature changes possible. This effect, too, allows shorter process times and lower energy consumption of the heat transfer device.

According to a preferred embodiment, the diverting device is provided at one end of the carrier structure. This makes it possible for that part of the directed gas flow that is diverted by the diverting device to be able to be fed to the inlet of the flow path of the carrier structure. In particular, the diverting device is provided at that end of the carrier structure that faces the directed gas flow when the apparatus is accommodated in the heat transfer device. The diverting device can be provided on the front face of the carrier structure. The diverting device can be provided in a releasable manner or can be connected to the carrier structure in a non-releasable manner Consequently, as a result of this preferred configuration, complete throughflow of the flow path with an increased flow rate is allowed, since, in addition, the diverted part of the directed flow is fed to the inlet, resulting in particularly short process times and a particularly low energy requirement of the heat transfer device.

The diverting device can have a diverting plate which, when the apparatus is accommodated in the heat transfer device, is provided preferably perpendicularly to the directed gas flow. The diverting plate can be formed from metal, wherein other materials are also conceivable here. The diverting plate can be configured as a metal sheet. This configuration allows a particularly cost-effective and yet effective diverting device.

According to a preferred embodiment, the diverting device has a diverting funnel which widens in a funnel shape from the inlet of the flow path. The diverting funnel extends preferably from the inlet of the flow path in a funnel shape in the direction of the directed gas flow. In other words, the directed gas flow of the heat transfer device is fed by the diverting funnel to the inlet of the flow path of the carrier structure, or focused thereon. In the context of the present invention, a funnel does not require rotational symmetry, although the diverting funnel can also be formed in a rotationally symmetrical manner A diverting funnel according to the present invention merely requires a cross-sectional area that increases in size in the direction of the funnel axis. This preferred configuration results in particularly short process times and particularly low energy consumption of the heat transfer device, since the gas flow rate through the carrier structure can be maximized by the diverting funnel.

Furthermore, the diverting device can have a flexible material with a holding device. The flexible material can be, for example, a rubber. Preferably, the flexible material is a material which has a temperature resistance of at least 200° C. The holding device allows the flexible material to be fastened releasably to the heat transfer device and/or the carrier structure. Preferably, the holding device allows the flexible material to be fastened releasably to the carrier structure. In this case, the flexible material can be connected fixedly to the heat transfer device, for example an autoclave. The flexible material can be formed in a sail- or bag-like manner This configuration allows particularly high flexibility and easy handling of the apparatus. By way of the flexible material, dimensional and/or positional fluctuations between the carrier structure and heat transfer device can be compensated, such that the effectiveness of the apparatus is ensured over a broad spectrum of conditions. Furthermore, the dimensions of the apparatus can be reduced, since the flexible diverting device is able to be placed on the carrier structure or is provided fixedly on the heat transfer device, resulting in better handling. This in turn simplifies the equipping of the heat transfer device, resulting in even shorter process times.

It is particularly easy to handle the apparatus when the holding device comprises a zipper. Via the zipper, it is possible, in this preferred embodiment, for the carrier structure and/or the heat transfer device to be connected to the flexible material. For example, a zipper for connecting the flexible material to the carrier structure is provided. In order to produce a component, all that is then necessary is for the carrier structure, together with the fiber composite resin system, to be conveyed into the heat transfer device, this being particularly simple since the diverting device is decoupled from the carrier structure in this state. Subsequently, the carrier structure is coupled to the flexible material via the zipper. In order to produce a further component, the zipper is opened and the same procedure repeated.

According to a preferred embodiment, the flow path of the carrier structure extends from the inlet, which faces the directed flow when the apparatus is accommodated in the heat transfer device, to an outlet on the opposite side of the carrier structure along the entire fiber composite resin system when the latter is accommodated by the carrier structure. In other words, the carrier structure has a flow path which runs through the entire structure from the front side to the rear side. Likewise, the carrier structure has at least one further flow path between the inlet and an opening in one of the side faces between the inlet and outlet of the carrier structure. If the carrier structure is a cuboidal structure, in which the inlet is provided in one of the side faces and the outlet in the opposite side face, at least one of the remaining parallel side faces thus has an opening. Preferably, each of the side faces between the inlet and outlet has at least one opening which is connected to the inlet, and more preferably, each has a plurality of openings connected to the inlet. Thus, the carrier structure comprises at least one, preferably several, flow path(s) between the inlet and side face between the inlet and outlet. This configuration provides a carrier structure which, as a result of extensive permeation with flow paths, allows particularly good heat exchange with the gas flowing through and at the same time has a low weight.

The carrier structure can in this case be formed in a honeycomb-like manner from individual chambers which are arranged beneath a top side. The individual chambers can each be configured in a cuboidal manner Each of the chambers has at least one opening in its side faces, i.e., its faces which have an extent component perpendicular to the top side. Adjacent chambers are therefore each connected together via an opening. This has the result that each chamber is connected to every other chamber of the carrier structure via a flow path. In particular, the carrier structure thus also has, in every side face, a plurality of openings which are connected together via a flow path.

According to a preferred embodiment, the apparatus furthermore has a sealing element for sealing off the at least one opening in the side face between the inlet and outlet. A sealing element is understood, according to the invention, to be a device which blocks the corresponding flow path. Complete hermetic sealing is not necessary here, but possible. This results in the advantage that gas, which flows into the carrier structure through the inlet, cannot escape from the carrier structure out of the side faces between the inlet and outlet. As a result, the flow is made to flow through the carrier structure from the inlet to the outlet. This results in more uniform heating of the carrier structure and thus of the fiber composite resin system, resulting in shorter process times and a lower energy requirement of the heat transfer device.

Furthermore, the carrier structure, preferably, has a shaping surface in order to impart the shape of the fiber composite component to be produced with the apparatus on the fiber composite resin system. This shaping surface is particularly preferably configured for producing a fuselage shell, a wing shell, a tail unit part or a rib for an aircraft. In the case of larger fiber composite components, like those mentioned above, the present invention provides a particular effect. This is due to the fact that, in particular in the case of larger components, the heating and cooling times can be much longer than the holding times for curing. Therefore, particularly great advantages can be achieved in the context of the present invention in the case of these components on account of the quicker and more uniform heating.

Preferably, the shaping surface is curved inward in the widthwise direction of the carrier structure, wherein the apparatus is furthermore configured to feed a part of the directed gas flow to the curved region with the diverting device, such that this part of the gas flow can flow past the fiber composite resin system through the curved region. This configuration allows, in particular, carrier structures with high flow resistance in the flow channel to heat the fiber composite resin system relatively quickly.

Furthermore, the present invention relates to an autoclave for producing a fiber composite component for aviation. The autoclave has a chamber which is preferably formed in a cylindrical manner, a flow generating device for generating a directed gas flow in the chamber, and an apparatus for carrying a fiber composite resin system according to one of the above-described embodiments. In this case, the autoclave is configured such that at least a part of the directed gas flow is able to be fed to the inlet of the carrier structure by being diverted by the diverting device. As regards the advantages of this autoclave, reference is made to the above-described advantages in conjunction with the apparatus for carrying a fiber composite resin system.

Particularly preferably, the autoclave is, in this case, configured such that the diverting device extends between the carrier structure and the chamber inner face in order, in this way, to close a free space between these components, in particular completely. This results in particularly short process times and particularly low energy consumption of the heat transfer device, since, in this way, substantially all of the gas flow is able to be fed to the inlet of the carrier structure within the autoclave chamber. The entire gas flow in the autoclave is then actively involved in the heat exchange operation.

Furthermore, the present invention relates to a method for producing a fiber composite component for an aircraft, which preferably uses an autoclave according to the above-described embodiments. The method comprises the feeding of a directed gas flow to a carrier structure which carries a fiber composite resin system, wherein the carrier structure has a flow path which extends from an inlet, which faces the directed gas flow, along the fiber composite resin system, and the diverting of a part of the directed gas flow in order to feed this part to the inlet of the flow path of the carrier system. As regards the advantages of this method, reference is made to the advantages in conjunction with the above-described embodiments of the autoclave and of the apparatus for carrying a fiber composite resin system.

### BRIEF DESCRIPTION OF THE DRAWINGS

FIG. 1 shows an isometric view of a carrier structure for a fiber composite resin system, as is known from the prior art.

FIG. 2 shows a schematic side view of an autoclave with a carrier structure which carries a fiber composite resin system, as is known from the prior art.

FIG. 3 shows a front view of the autoclave shown in FIG. 2, together with the carrier structure and fiber composite resin system.

FIG. 4 shows an apparatus for carrying a fiber composite resin system according to a first embodiment of the present invention.

FIG. 5 shows a schematic side view of an autoclave with an apparatus, provided therein, for carrying a fiber composite resin system according to a second embodiment of the present invention.

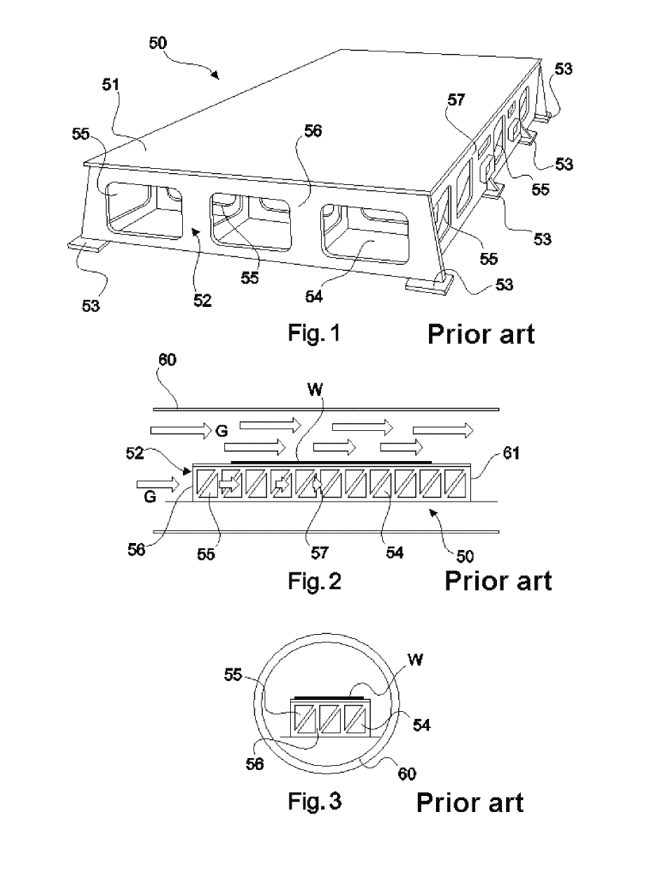

### DETAILED DESCRIPTION OF THE PREFERRED EMBODIMENTS

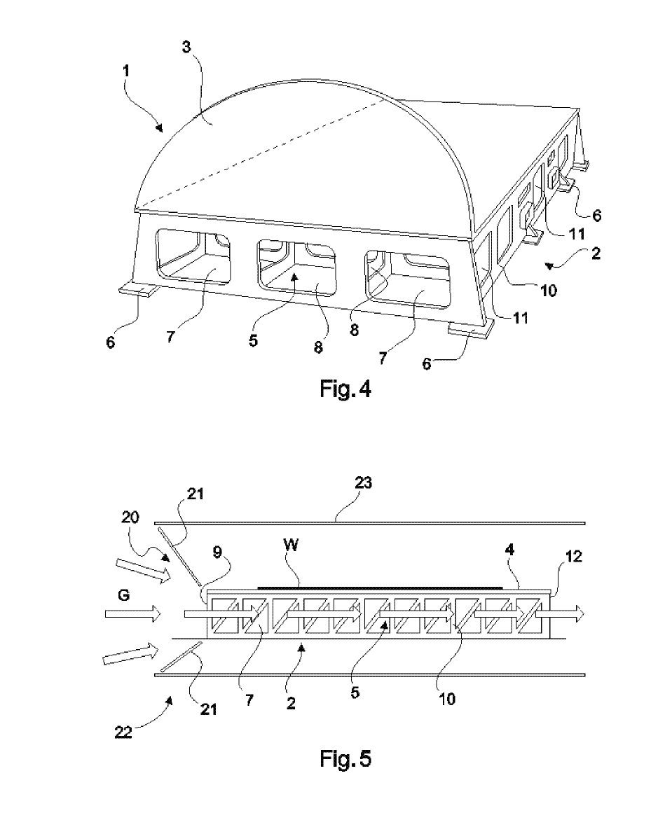

FIG. 4 shows an apparatus for carrying a fiber composite resin system 1 in a heat transfer device according to a first embodiment of the present invention. The apparatus 1 has a carrier structure 2 and a diverting device 3.

The carrier structure 2 is preferably formed in a cuboidal manner with a continuous top side 4. Other forms are also conceivable here. Provided on the top side 4 of the carrier structure 2 is a shaping surface. The shaping surface is configured such that the final shape, i.e., the shape of the finished fiber composite material, can be imparted on a fiber composite resin system which is accommodated by this surface. In particular, the shaping surface of this embodiment is designed to form extensive fiber composite components, such as a fuselage shell, a wing shell, a tail unit part or a relatively large rib. In the context of this embodiment, however, other forms of the shaping surface are also conceivable here. In FIG. 4, the shaping surface is illustrated merely as a level plane.

In the context of the present invention, one or more pressure pieces for weighing down the fiber composite resin system can be provided on a fiber composite resin system which has been placed on the shaping surface, in order to keep the fiber composite resin system in form.

The carrier structure 2 according to the embodiment has, beneath the top side 4, a honeycomb-like structure 5. This honeycomb-like structure 5, as a whole, is preferably likewise formed in a cuboidal manner and supported on a plurality of feet 6. It should be noted here that other configurations of the honeycomb-like structure, for example a cylindrical configuration, are also conceivable. The feet 6 are also merely optional for this embodiment.

The honeycomb-like structure 5 is constructed from individual chambers 7 which each have an opening 8 in every side face, i.e., in every face with an extent component perpendicular to the top side 4. Thus, the honeycomb-like structure 5, as a whole, also has openings 8 in every side face. To be more precise, the honeycomb-like structure 5 comprises openings 8 in the front face 9, in the rear face 12, shown in FIG. 5, on the opposite side from the front face, and in the two-parallel side faces 10 of the honeycomb-like structure 5, which are arranged between the front face 9 and the rear face 12 of the honeycomb-like structure 5.

Each of the chambers 7 of the honeycomb-like structure 5 is thus connected to every other chamber 7 via a flow path. In particular, the honeycomb-like structure 5 has a flow path between the openings 8 of the chambers 7 in the front face 9, the inlet, and the openings 8 of the chambers 7 in the rear face 12, the outlet. To be more precise, the present embodiment has a plurality of flow paths between the inlet and outlet.

Furthermore, the carrier structure 2 of this embodiment has a plurality of sealing elements 11. The sealing elements 11 are provided on the opposite side faces 10 of the carrier structure 2 in order to seal off all the openings 8 in the side faces 10. These sealing elements 11 preferably close any flow path within the honeycomb-like structure 5 between the openings 8 of the side faces 10 and the inlet or the outlet, respectively. In other words, these sealing elements ensure that the gas flow that has entered the honeycomb-like structure 5 through the inlet can escape only through the outlet. Any escape via openings 8 between the inlet and outlet is thus prevented by the sealing elements 11. In the context of the present embodiment, it is likewise conceivable for only some openings 8 in the side face 10 between the inlet and outlet to be closed by a sealing element 11.

Furthermore, this first preferred embodiment has a diverting device 3. The diverting device 3 is provided on the front face 9 of the honeycomb-like structure 2 and extends preferably perpendicularly to the top side 4. The diverting device 3 is configured, in this first embodiment, in the form of a diverting plate which extends from the top side 4 and can have a semicircular shape, in order in this way to fill an intermediate space between the carrier structure 2 and the inner face of an autoclave with a circular cross section. Other forms of this diverting plate are also conceivable here. Preferably, however, the diverting plate is configured such that it can close a free space between the carrier structure and the heat transfer device in order, in this way, to divert a part of a gas flow in the heat transfer device and to feed it to the inlet of the honeycomb-like structure 5. The diverting device 3 can also be configured in some other way in the context of this first embodiment. For example, it can be configured in a funnel-shaped manner and/or comprise a flexible material which is able to be connected to the carrier structure 2 and/or a heat transfer device in particular via a zipper.

FIG. 5 shows an apparatus 20 for carrying a fiber composite resin system W according to a second embodiment of the present invention. The apparatus 20 comprises a carrier structure 2 which is configured in a manner corresponding to the carrier structure 2 of the first embodiment. The carrier structure 2 will accordingly not be described again in the context of this second embodiment.

Furthermore, the apparatus 20 for carrying a fiber composite resin system W according to this second embodiment comprises a diverting device 21 which is configured in a funnel-shaped manner The diverting funnel 21 of this second embodiment is configured such that it widens from the inlet of the honeycomb-like structure 5 at the front face 9 in the direction of the directed gas flow G within a heat transfer device, for example an autoclave. Other configurations of the diverting device are also conceivable here.

The apparatus 20 for carrying a fiber composite resin system W according to this second embodiment is accommodated in a heat transfer device 22 in FIG. 5. The heat transfer device 22 is in particular an autoclave, but can also be a furnace, for example. Preferably, the heat transfer device is formed with a chamber 23 which is, for example, cylindrical. The heat transfer device 22 furthermore has a flow generating device (not shown) in order to generate a directed gas flow G. The directed gas flow G in this case flows preferably parallel to an axis of symmetry of the heat transfer device. If the heat transfer device is formed in a cylindrical manner, the directed gas flow preferably flows along the cylinder axis.

In the context of the second embodiment of the apparatus 20 for carrying a fiber composite resin system W according to the present invention, the funnel-shaped diverting device 21 is configured such that it extends from the inlet of the carrier structure 2 at the front face 9 to the inner face of the chamber 23 of the heat transfer device. Other configurations are also conceivable here.

In order to cure a fiber composite resin system W which is provided on a shaping surface that is arranged on the top side 4 of the carrier structure 2, the entire carrier structure 2, together with the workpiece W, is pushed into a heat transfer device 22, as can be seen in FIG. 5. Subsequently, a directed gas flow G is generated by the heat transfer device 22. The directed gas flow G is diverted by the diverting device 21 in order, in this way, to feed the entire gas flow within the heat transfer device 22 to the inlet of the carrier structure 2. On account of the sealing elements 11 at the side faces 10 of the carrier structure 2, the entire gas flow G generated in the heat transfer device 22 flows from the inlet to the outlet of the carrier structure and thus along the entire fiber composite resin system W. This results in uniform and high heat transfer between the gas flow, which is located within the carrier structure 2, and the carrier structure 2 and thus the fiber composite resin system W, this resulting in short process times and high energy efficiency.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An apparatus for carrying a fiber composite resin system in a heat transfer device, for transferring heat between the fiber composite resin system and a directed gas flow, to produce a fiber composite component for an aircraft, comprising:
a carrier structure to carry the fiber composite resin system, wherein the carrier structure has at least one flow path which, when the apparatus is accommodated in the heat transfer device, extends from an inlet on a side facing the directed gas flow along the fiber composite resin system accommodated by the carrier structure, to allow heat exchange between the gas flow in the flow path and the fiber composite resin system, and
a diverting device to divert at least a part of the directed gas flow when the apparatus is accommodated in the heat transfer device, to feed this part to the flow path of the carrier structure.

2. The apparatus according to claim 1, wherein the diverting device is provided at one end of the carrier structure to feed the part of the directed gas flow to the inlet of the flow path of the carrier structure.

3. The apparatus according to claim 1, wherein the diverting device has a diverting plate.

4. The apparatus according to claim 1, wherein the diverting device has a diverting funnel which widens from the inlet of the flow path in a funnel shape in a direction of the directed gas flow when the apparatus is accommodated in the heat transfer device.

5. The apparatus according to claim 1, wherein the diverting device has a flexible material with a holding device which allows the flexible material to be fastened releasably to at least one of the heat transfer device or the carrier structure.

6. The apparatus according to claim 5, wherein the holding device comprises a zipper.

7. The apparatus according to claim 1, wherein the flow path of the carrier structure extends from the inlet to an outlet on the opposite side of the carrier structure along the entire fiber composite resin system when the fiber composite resin system is carried by the carrier structure, and the apparatus furthermore has at least one further flow path between the inlet and an opening in a side face which is arranged between the inlet and the outlet.

8. The apparatus according to claim 7, wherein the carrier structure is formed in a honeycomb-like manner from individual chambers and a top side, wherein each of the chambers has an opening in its side faces, that is, its faces having a component perpendicular to the top side, such that adjacent chambers are each connected together via an opening.

9. The apparatus according to claim 7, which has a sealing element for sealing off the at least one opening in the side face between the inlet and outlet. wherein the apparatus is configured such that every opening in the side faces between the inlet and outlet is sealed off with one or more sealing elements.

10. The apparatus according to claim 1, wherein the carrier structure has a shaping surface to impart a shape of the fiber composite component to be produced with the apparatus on the fiber composite resin system.

11. The apparatus according to claim 10, wherein the shaping surface is configured to produce a fuselage shell, a wing shell, a tail unit part or a rib for an aircraft.

12. The apparatus according to claim 10, wherein the shaping surface is curved inward in the widthwise direction of the carrier structure, wherein the apparatus is furthermore configured to feed a part of the directed gas flow to the curved region with the diverting device such that this part of the gas flow can flow past the fiber composite resin system through the curved region.

13. An autoclave for producing a fiber composite component for aviation, having
a chamber,
a flow generating device for generating a directed gas flow in the chamber, and
an apparatus for carrying a fiber composite resin system according to claim 1,
wherein the autoclave is configured such that at least a part of the directed gas flow can be fed to the inlet of the carrier structure by being diverted by the diverting device.

14. The autoclave according to claim 13, which is configured such that the diverting device extends from the carrier structure to the chamber inner face in order to close a free space between these components.

15. A method for producing a fiber composite component for an aircraft, using an autoclave according to claim 13, comprising
feeding a directed gas flow to a carrier structure which carries a fiber composite resin system, wherein the carrier structure has a flow path which extends from an inlet, which faces the directed gas flow, along the fiber composite resin system, and
diverting a part of the directed gas flow in order to feed this part to the inlet of the flow path of the carrier structure.

16. The apparatus of claim 1, wherein the heat transfer device comprises an autoclave.

17. The apparatus according to claim 3, wherein the diverting plate, which, when the apparatus is accommodated in the heat transfer device, is arranged perpendicularly to the directed gas flow.

18. The apparatus according to claim 3, wherein the diverting device is made of rubber.

19. The apparatus according to claim 9, wherein the apparatus is configured such that every opening in the side faces between the inlet and outlet is sealed off with one or more sealing elements.

20. The autoclave according to claim 13, wherein the chamber has the form of a cylinder.
